(19) United States
(12) Patent Application Publication
(10) Pub. No.: US 2003/0227178 A1
(43) Pub. Date: Dec. 11, 2003

(54) Safety unlocking device of a door lock of a motor vehicle

(76) Inventor: Josef Zsolt Hofhauser, Wurzburg (DE)

Correspondence Address: KENYON & KENYON, ONE BROADWAY, NEW YORK, NY, 10004, US

(21) Appl. No.: 10/395,682

(22) Filed: Mar. 24, 2003

(30) Foreign Application Priority Data
Mar. 30, 2002 (DE) 102 14 377.3

(51) Int. Cl. E05C 3/06

(52) U.S. Cl. 292/216

(57) ABSTRACT

A safety unlocking device of a door lock of a motor vehicle, e.g., a door lock on a tailgate of a luggage compartment of a passenger vehicle, which compartment may be provided with a child seat, in which the door lock is arranged, e.g., for actuation by electric motor and central locking which may be controlled remotely, and in which the door lock is provided with an inside door handle for opening the door lock from the vehicle interior. The door lock may be unlocked from each of its locking states by an inside door handle, which is arranged at a remote point, using a Bowden cable. The inside door handle includes a handle pivotable about an axis of rotation, consists of a basic body and has a slide which may be displaced in the same axis of rotation on the basic body, a lever which is mounted in the axis of rotation of the basic body such that it may pivot separately and independently in the same manner as the basic body, for actuating the Bowden cable, a coupling element connected fixedly to the slide and with which the slide, depending on its sliding position, locks the lever in place for common pivoting of the basic body together with the slide and of the lever or keeps the basic body together with the slide and the lever uncoupled, springs which bring about the basic positions of the basic body and of the slide which may be displaced thereon.

### CROSS-REFERENCE TO RELATED APPLICATIONS

The present application claims priority to Application No. 102 14 377.3, filed in the Federal Republic of Germany on Mar. 30, 2002, which is expressly incorporated herein in its entirety by reference thereto.

### FIELD OF THE INVENTION

The invention relates to a safety unlocking device of a door lock of a motor vehicle.

### BACKGROUND INFORMATION

In the case of safety unlocking devices of door locks of a motor vehicle, described, for example, in German Published Patent Application No. 100 45 026, opening of the door lock by the inside door handle can be prevented by a blocking device. These blocking devices can be shifted by hand between an active blocking position and a non-locking function with each shifting position being permanent until a next shifting operation, that is to say, the two different shifting positions may not and do not have to be permanently held by hand, since the blocking element is not acted upon in the various shifting functions by any forces effecting shifting. If the blocking action is cancelled by an appropriate shifting position of the blocking element, then the door lock can be opened from all of the locking states by simple actuation of the inside door handle. In the situation in which there are small children in the vicinity of the inside door handle in the vehicle, if the blocking element for the door lock is in a non-blocking shifting position there is no child-proof lock against inadvertent opening of the door lock. If the blocking element is in a blocking shifting position, a child-proof lock of this type is provided, but opening of the door lock by the inside door handle without problem is not possible, even in an emergency.

German Published Utility Model No. 299 22 605 describes a luggage-compartment lock for a vehicle, which can readily be opened, even when locked, by a person inadvertently trapped in a luggage compartment. However, this lock in the interior of the luggage compartment is not secured against unintentional, inadvertent opening by, in particular, a person in the luggage compartment. Thus, for a vehicle tailgate which bounds a passenger compartment adjacent to the tailgate in the vehicle rear, this lock does not constitute any safeguard against inadvertent opening by one of the people.

It is an object of the present invention to provide, for an inside door handle of the generic type, a safety unlocking device which, on the one hand, may prevent accidental, inadvertent opening of the door lock by small children, for example, and, on the other hand, may permit a desired, for example in an emergency, or required and intentional opening of the door lock by the inside door handle without any problem.

### SUMMARY

The above and other beneficial objects of the present invention may be achieved by providing a safety unlocking device as described herein.

A device according to an example embodiment of the present invention may be suitable for a passenger vehicle in which the door lock is arranged for actuation by an electric motor and for central locking which may be controlled remotely.

Further aspects and example embodiments of the present invention are described below.

The present invention is based on providing an inside door handle with a safety unlocking device which, in the case of a specifically intended opening of the door lock, may be actuated together with the inside door handle. In this case, the safety device is compelled to take up a basic position in which opening of the door lock by the inside door handle may be impossible if the safety device is not displaced at the same time temporarily away from its blocking function counter to a force, for example, a spring force. The device for temporarily displacing the unlocking device may be configured such that, in particular, a small child may not actuate it. Moreover, a configuration of this type may reliably ensure that the inside door handle may be inadvertently opened by accidentally touching the door lock with no intention of opening the door lock.

In an example embodiment of a device according to the present invention, the inside door handle may make opening of the door lock possible only from its basic position.

The unlocking device may be formed by the spring which secures the basic position of the slide of the safety unlocking device being arranged as a helical spring which is mounted directly on the coupling region of the lever, which actuates the Bowden cable from the unlocking device.

An example embodiment of the present invention is illustrated in the drawing.

### BRIEF DESCRIPTION OF THE DRAWING

FIG. 1 is a longitudinal cross-sectional view through a safety unlocking device in a schematic illustration.

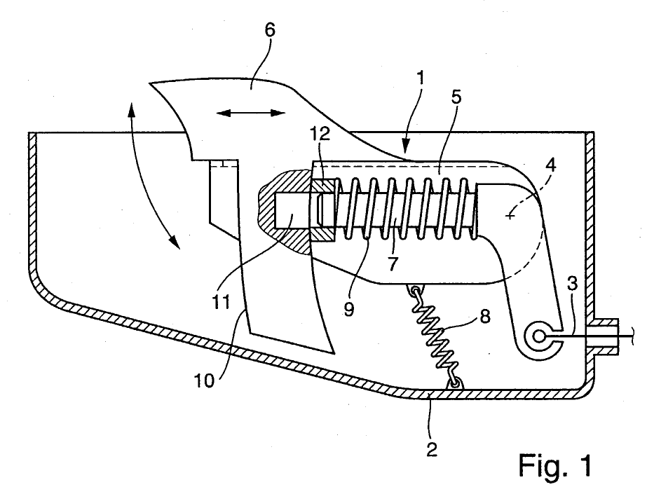

### DETAILED DESCRIPTION

The safety unlocking device is integrated in an inside door handle 1 which is fitted, within a shell 2, to, for example, a rear door of a vehicle.

The inside door handle 1 is used to actuate a Bowden cable 3 for unlocking a door lock.

In detail, the inside door handle 1 includes a basic door handle body 5 which is mounted in an axis of rotation 4, a slide 6 which is mounted displaceably on the basic body 5, and a lever 7 which acts directly on the Bowden cable 3 and is mounted in the axis of rotation 4 of the basic body for pivoting independently of the basic body 5.

A basic-body spring 8 keeps the basic body 5 in a basic position, in which the door handle 1 is in the unactuated normal state. A slide spring 9 keeps the slide 6 in a basic position which is to be provided with the non-actuated inside door handle 1 in its normal position.

The slide 6 has a longitudinal strut 10 having a coupling element 11 which is provided as a socket in the longitudinal strut 10. The coupling element 11 is suitable and intended for receiving a region of the lever 7 in such a manner that, when the basic body 5 is pivoted about the axis of rotation 4, the basic body 5 and the lever 7 may be pivoted only together with each other. The displaceable mounting of the slide 6 on the basic body 5 is used for the coupling element 11 to grasp the lever 7 so as to obtain a closed coupling.

The spring 9, which may ensure the basic position of the slide 6 on the basic body 5, is mounted on the lever 7 and is supported on a slideably designed region of the longitudinal strut 10 of the slide 6 via an intermediate body 12, which is mounted displaceably on the lever 7. The correspondence between the lever 7 and the coupling element 11, i.e., the socket in the longitudinal strut 10, is such that, when the slide 6 is displaced by hand counter to the pressure of the spring 9, closing of the coupling is possible exclusively in the basic position of the basic body 5.

The inside door handle with an integrated safety unlocking device functions as follows.

Starting from the basic position (illustrated in the drawing) of the door handle 1, the latter firstly may have to be pivoted via its basic body 5 about the axis of rotation 4 in order to open the door lock. Furthermore, the slide 6 may have to be displaced at the same time counter to the pressure of the spring 9 by an operator's hand grasping the basic body 5. Displacing the slide 6 in this manner in the basic position of the basic body 5 causes the coupling to close, by the coupling element 11 being pushed onto the lever 7, in which case the lever 7 moves through the intermediate body 12. With the coupling closed and the slide 6 held counter to the force of the spring 9, the inside door handle 1 is able, in the case of a coupling closed in such a manner, to open the door lock if the handle is pivoted about the axis of rotation 4.

As soon as the inside door handle 1 is not being actuated by an operator's hand, it slips into its basic position, with both the basic body 5 and the slide 6 being in their respective basic positions. If, in this state, the door handle 1 is actuated without the slide 6 being displaced counter to the pressure of the spring 9, then only the basic body 5 pivots about the axis of rotation 4, with, at the same time, the longitudinal strut 10 sliding along the intermediate body 12 under the pressure of the spring 9 without a coupling connection taking place.

The position of the slide 6 on the basic body 5 of the inside door handle 1, on the one hand, and the setting of the spring force 9 to a relatively large actuating force, on the other hand, may be selected in such a manner that unintentional opening of the door lock may be reliably prevented with the inside door handle 1 according to an example embodiment of the present invention.

What is claimed is:

1. A safety unlocking device of a door lock of a motor vehicle, the door lock including an inside door handle arranged to open the door lock from a vehicle interior, the door lock unlockable from each locking state thereof by the inside door handle, arranged at a remote location, by a Bowden cable, comprising:
a handle pivotable about an axis of rotation and including a basic body and a slide displaceable on the basic body in the axis of rotation;
a lever mounted in the axis of rotation of the basic body and pivotable separately and independently in a same manner as the basic body to actuate the Bowden cable;
a coupling element connected fixedly to the slide and, in accordance with a sliding position of the slide, arranged with the slide one of to lock the lever in place for common pivoting of the basic body with the slide and of the lever and to keep the basic body together with the slide and the lever uncoupled; and
springs configured to bring about basic positions of the basic body and of the slide, the basic body and the slide arranged dispalceably on the springs.

2. The device according to claim 1, wherein the door lock includes a door lock on a tailgate of a luggage compartment of a passenger vehicle, the luggage compartment providable with a child seat.

3. The device according to claim 1, wherein the coupling between the slide and the lever is lockable exclusively in the basic position of the basic body.

4. The device according to claim 1, wherein the coupling element of the slide includes a socket in a longitudinal strut provided on the slide, the spring configured to bring about the basic position of the slide on the basic body including a helical spring surrounding a coupling region of the lever that is introduceable into the coupling element of the glide, the helical spring, via an intermediate body mounted displaceably on the lever, arranged to bear in a slideable manner on the longitudinal strut to bring about different pivoting movements between the lever and basic body together with the slide.
